(19) United States
(12) Patent Application Publication
(10) Pub. No.: US 2004/0208380 A1
(43) Pub. Date: Oct. 21, 2004

(54) System for reproducing moving image from JPEG 2000 encoded data stream

(76) Inventors: Shin Aoki, Kanagawa (JP); Takashi Maki, Kanagawa (JP); Hiroyuki Sakuyama, Tokyo (JP); Takao Inoue, Kanagawa (JP); Taku Kodama, Kanagawa (JP); Ikuko Yamashiro, Kanagawa (JP); Takanori Yano, Kanagawa (JP); Akira Takahashi, Kanagawa (JP); Keiichi Ikebe, Kanagawa (JP); Takeshi Koyama, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/783,743

(22) Filed: Feb. 20, 2004

(30) Foreign Application Priority Data
Feb. 20, 2003 (JP) 2003-043189

(51) Int. Cl. G06K 9/36

(52) U.S. Cl. 382/232

(57) ABSTRACT

A system is disclosed for reproducing a moving image encoded into an encoded data stream in accordance with JPEG 2000 that includes a reproduction apparatus and a transmission apparatus. The reproduction apparatus transmits a reproduction condition being set by a setting unit provided therein, the reproduction condition set in accordance with the user's operation, to the transmission apparatus. The transmission apparatus transmits an encoded data stream reconfigured by a reconfiguration unit based on the reconfiguration method determined by a determination unit based on the reproduction condition. When determining the reconfiguration condition, the determination unit may take a traffic condition of a communication channel into consideration. According to the above embodiments, the system does not need to transmit an original encoded data stream via the communication channel but can transmit the reconfigured encoded data stream that contains only encoded data for satisfying a user's requirement.

The present application claims priority to the corresponding Japanese Application No. 2003-043189, filed on Feb. 20, 2003, the entire contents of which are hereby incorporated by reference.

### BACKGROUND OF THE INVENTION

1. Field of the Invention

The present invention generally relates to a system for reproducing a moving image, and more particularly, to the reproducing of a moving image encoded into an encoded data stream in accordance with JPEG 2000.

2. Description of the Related Art

Japanese Patent Laid-Open Application No. 10-42185 (referred to as document 1) discloses a server computer that encodes a moving image captured with a video camera into MPEG data or Motion JPEG data, and transmits the data to a client computer via a network. The server computer changes the frame rate of the Motion JPEG data or the data amount of the MPEG data depending on the traffic in the network.

Japanese Patent Laid-Open Application No. 2000-13779 (referred to as document 2) discloses a system that transmits video and audio content from a server computer to a client computer. The system determines the bit rate and the format of the content depending on the properties of the communication channel and the capabilities of the client.

Japanese Patent Laid-Open Application No. 2001-36891 (referred to as document 3) discloses a system that generates a partial image by decomposing a large composite image captured with multiple cameras. The system generates the partial image by averaging pixel values and by increasing scan lines (up-conversion).

MPEG and Motion JPEG are widely used for the compressing of moving images. JPEG 2000 (ISO/IEC FCD 15444-1) and Motion JPEG 2000 (ISO, FCD 15444-3, the extension of JPEG 2000) are expected to take the place of MPEG and Motion JPEG. For example, JPEG 2000 is described in detail in Y. Nomizu, “Next Generation Image Coding Method JPEG 2000,” Feb. 13, 2001, Triceps, the entire contents of which are hereby incorporated by reference. Motion JPEG 2000 regards a moving image as multiple still images continuing time-wise, each constituting a frame. The frames are encoded by JPEG 2000 independently from each other. That is, Motion JPEG 2000 encodes the moving images into encoded data streams of JPEG 2000.

It is preferable that, when reproducing a moving image, a user can make a decision on the resolution, the image quality, and the frame rate of the moving image to be reproduced in consideration of how the moving image is to be reproduced. For example, when the moving image is to be displayed on a small screen, a resolution suitable for the screen size is high enough. Too high a resolution results in merely increasing the processing time and data transfer time. The image quality and the frame rate of the moving image may be determined in the same manner. However, the techniques disclosed in the above documents 1 and 2 determine the bit rate and the frame rate of a moving image based on the state of the communication channel and the capacity of the client computer and, as a result, fail to reflect such intentions of a user.

When reproducing a moving image, a user may desire to simulate the panning, tilting, and zooming of the moving image. The technique disclosed in the above document 3 supports such simulation, but involves the averaging of pixel values and the increasing of scan lines, which make the reproducing of the moving image complicated.

### SUMMARY OF THE INVENTION

A system for reproducing moving image from JPEG 2000 encoded data stream is described. In one embodiment, the system reproduces a moving image from an encoded data stream encoded in accordance with a coding method, where the encoded data stream being reconfigurable without decoding, and comprises: a reproduction apparatus that reproduces the moving image and a transmission apparatus that transmits the encoded data stream to the reproduction apparatus, the transmission apparatus being connected to the reproduction apparatus via a communication channel. The reproduction apparatus further comprises a setting unit that sets a reproduction condition in response to a user's operation. The reproduction condition is transmitted to the transmission apparatus. The transmission apparatus further comprises a determination unit that determines a reconfiguration method of the encoded data stream based on the reproduction condition received from the reproduction apparatus, and a reconfiguration unit that reconfigures the encoded data stream to be transmitted to the reproduction apparatus based on the reconfiguration method determined by the determination unit.

### BRIEF DESCRIPTION OF THE DRAWINGS

FIG. 1 is a block diagram showing an image reproducing system according to an embodiment of the present invention;

FIG. 2 is a flowchart for illustrating the operation of a reproduction condition setting unit according to the embodiment;

FIG. 3 is a flowchart for illustrating the operation of a reconfiguration method determining unit according to the embodiment;

FIGS. 4A and 4B are schematic diagrams for illustrating the changing of a window size and the relation between window size and resolution;

FIG. 5 is a schematic diagram for illustrating a sliding adjuster for adjusting the balance between image quality and frame rate according to an embodiment;

FIGS. 6A and 6B are schematic diagrams for illustrating the relation between panning, tilting, and zooming of a moving image, and the range of the moving image to be displayed;

FIG. 7 is a schematic diagram showing an exemplary screen in which multiple moving images are displayed according to an embodiment;

FIG. 8 is a schematic diagram showing an image reproducing system according to another embodiment of the present invention;

FIG. 9 is a block diagram for illustrating the JPEG 2000 algorithm;

FIGS. 10A through 10D are schematic diagrams for illustrating the decomposing of a tile using 2-dimensional wavelet transform the decomposition level of which is 3;

FIG. 11 is a data diagram showing the structure of an encoded data stream of JPEG 2000; and

FIG. 12 is a schematic diagram for illustrating tiles, precincts, and code blocks.

### DETAILED DESCRIPTION OF THE PREFERRED EMBODIMENTS

One or more embodiments of the present invention include a novel and useful image reproducing system in which one or more of the above problems are eliminated.

Another specific embodiment of the present invention includes an image reproducing system that reproduces a moving image encoded into encoded data streams of JPEG 2000.

An encoded data stream of JPEG 2000 can be reconfigured into a new encoded data stream of different resolution, different image quality, different region, or different component without decompressing the encoded data stream.

To achieve at least one of the above embodiments, a system for reproducing a moving image from an encoded data stream encoded in accordance with a coding method, where the encoded data stream is reconfigurable without decoding, according to the present invention, includes: a reproduction apparatus that reproduces the moving image; and a transmission apparatus that transmits the encoded data stream to the reproduction apparatus, the transmission apparatus being connected to the reproduction apparatus via a communication channel. The reproduction apparatus further comprises a setting unit that sets a reproduction condition in response to a user's operation, where the reproduction condition is transmitted to the transmission apparatus. The transmission apparatus further comprises a determination unit that determines a reconfiguration method of the encoded data stream based on the reproduction condition received from the reproduction apparatus, and a reconfiguration unit that reconfigures the encoded data stream to be transmitted to the reproduction apparatus based on the reconfiguration method determined by the determination unit.

The reproduction apparatus transmits the reproduction condition set by the setting unit provided therein, and the reproduction condition is set in accordance with the user's operation, to the transmission apparatus. The transmission apparatus transmits an encoded data stream reconfigured by the reconfiguration unit based on the reconfiguration method determined by the determination unit in response to the reproduction condition. When determining the reconfiguration condition, the determination unit may take a traffic condition of the communication channel into consideration. According to the above embodiments, the system does not need to transmit an original encoded data stream via the communication channel but can transmit the reconfigured encoded data stream that contains only encoded data for satisfying a user's requirement. The reconfiguring of the encoded data stream reduces the size of the encoded data stream and the traffic in the communication channel, and reduces data amount that the reproduction apparatus needs to process.

According to another embodiment of the present invention, a system for reproducing a moving image from an encoded data stream encoded in accordance with a coding method, where the encoded data stream being reconfigurable without decoding, includes: a reproduction apparatus that reproduces the moving image; and a transmission apparatus that transmits the encoded data stream to the reproduction apparatus. The transmission apparatus is connected to the reproduction apparatus via a communication channel. The reproduction apparatus further comprises a setting unit that sets a reproduction condition in response to a user's operation, where the reproduction condition is transmitted to the transmission apparatus, and a determination unit that determines a reconfiguration method of the encoded data stream based on the reproduction condition received from the reproduction apparatus. The transmission apparatus further comprises a reconfiguration unit that reconfigures the encoded data stream to be transmitted to the reproduction apparatus based on the reconfiguration method determined by the determination unit.

As described above, the determination unit may be disposed not in the transmission apparatus but in the reproduction apparatus. The reconfiguration method determined by the determination unit is transmitted from the reproduction apparatus to the transmission apparatus, and the reconfigured encoded data stream is transmitted from the transmission apparatus to the reproduction apparatus in this case.

Other embodiments, features, and advantages of the present invention will become more apparent from the following detailed description when read in conjunction with the accompanying drawings.

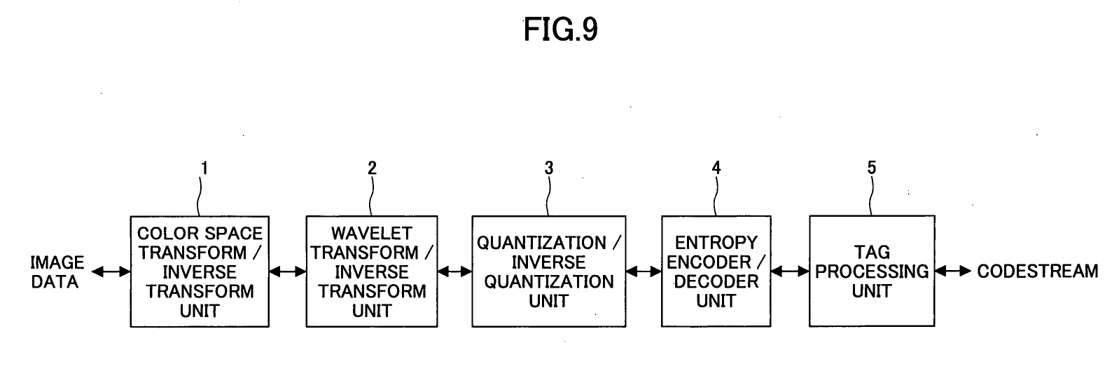

A description of JPEG 2000 is given to make the detailed description of the embodiments easy to understand. FIG. 9 is a block diagram for illustrating the algorithm for compressing and decompressing an image in JPEG 2000. The image to be compressed is decomposed into components, and each component is divided into exclusive rectangular regions (tiles). Tiles of a component are processed tile by tile. Alternatively, an image may be compressed as a whole without being divided into tiles.

A color space transform/inverse transform unit 1 transforms the color space of a tile from RGB or CMY to YCrCb, for example, for improving compression ratio. This step, however, may be omitted, if necessary.

After the color space of the tile is transformed, a wavelet transform/inverse transform unit 2 transforms the tile into multiple sub-bands in accordance with 2-dimensional discrete wavelet transform.

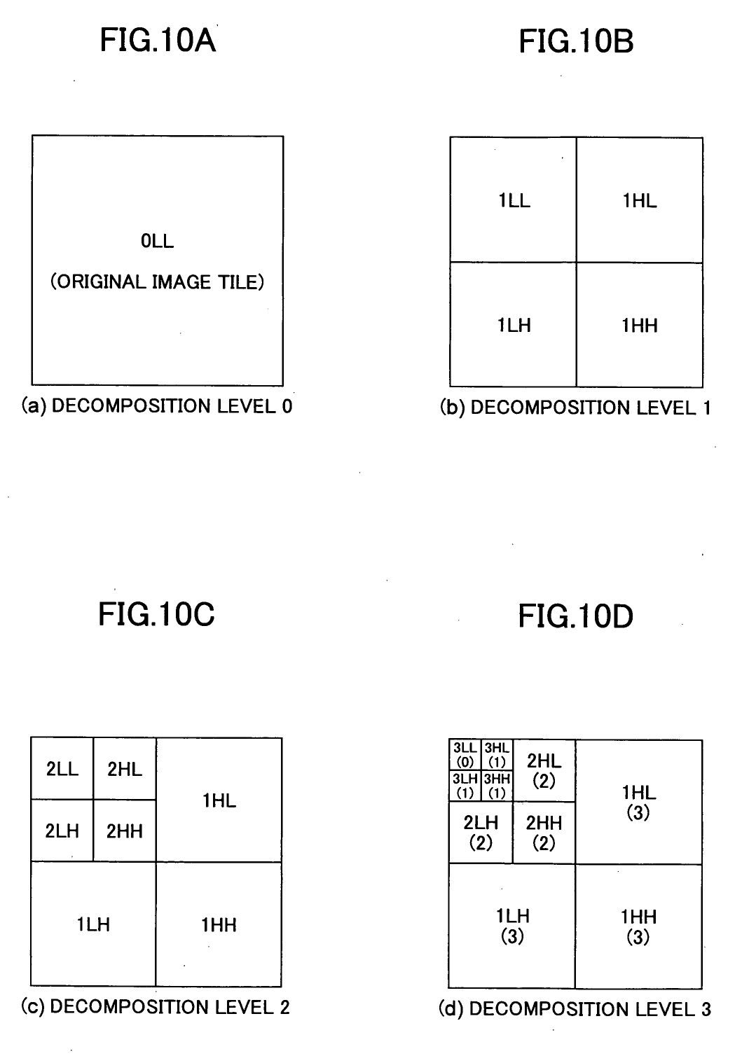

FIGS. 10A through 10D are schematic diagrams for illustrating the decomposing of a tile into multiple sub-bands in which the number of decomposition levels is 3. Numerals in parentheses shown in FIG. 10D indicate corresponding resolution levels.

A quantization/inverse quantization unit 3 transforms wavelet coefficients of each sub-band. JPEG 2000 supports both lossless compression and lossy compression. In lossless compression, the width of the quantization step is always 1, and as a result, the wavelet coefficients are not actually quantized.

An entropy encoder/decoder unit 4 transforms the quantized sub-band coefficients into entropy codes. A block-based method of encoding a bit plane called Embedded Block Coding with Optimized Truncation (EBCOT) is used for encoding. EBCOT includes block dividing, coefficient modeling, and binary arithmetic encoding. The bit plane of quantized coefficients of each sub-band is encoded by a block called a code block from upper bits to lower bits.

A tag processing unit 5 generates packets by combining codes included in the code blocks generated by the entropy encoder/decoder unit 4. The tag processing unit 5 further generates an encoded data stream by arranging the packets in the order of progression and attaching needed tag information.

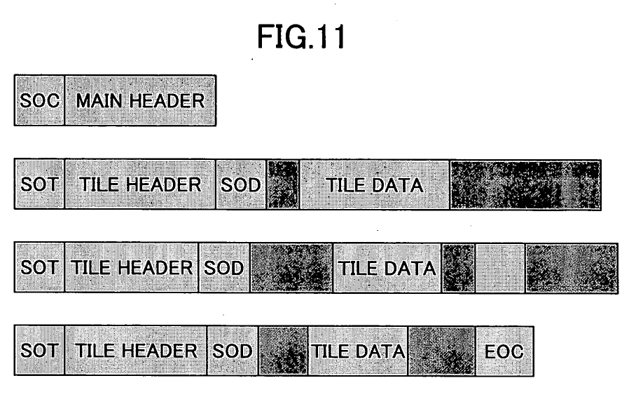

FIG. 11 is a data diagram for illustrating the format of an encoded data stream generated in accordance with JPEG 2000. As shown in FIG. 11, an encoded data stream starts with a SOC marker tag indicating the head of the encoded data stream. The SOC marker is followed by main header tag information indicating encoding parameters and quantization parameters, for example. The main header is followed by code data of each tile. The code data of each tile starts with a SOT marker tag. The SOT marker is followed by tile header tag information, a SOD marker tag, and tile data including codes of each tile. The last of the tile data is followed by an EOC marker tag indicating the end of the encoded data stream.

The decompressing of an encoded data stream is realized by following the above process in the opposite direction. The tag processing unit 5 divides the encoded data stream into codes of each tile. The codes are decoded by the entropy encoder/decoder unit 4 into wavelet coefficients. The wavelet coefficients are inversely quantized by the quantization/inverse quantization unit 3, and transformed by the wavelet transform/inverse transform unit 2 in accordance with 2-dimensional discrete wavelet transform. As a result, the image of each tile is reproduced. The color space of the reproduced image is transformed into RGB, for example, by the color space transform/inverse transform unit 1.

As described above, an image is divided into multiple regions, and each region is compressed independently. The regions into which the image is divided may be precincts, beside the tiles and the code blocks. Their relative sizes are:

image≧tile≧sub-band≧precinct≧code block.

A region in each sub-band corresponds to a region in the image (original image) one by one. Accordingly, a precinct that is a specific region of a tile corresponds to a region in the original image one by one, and a code block that is also a specific region of a tile corresponds to a region in the original image one by one.

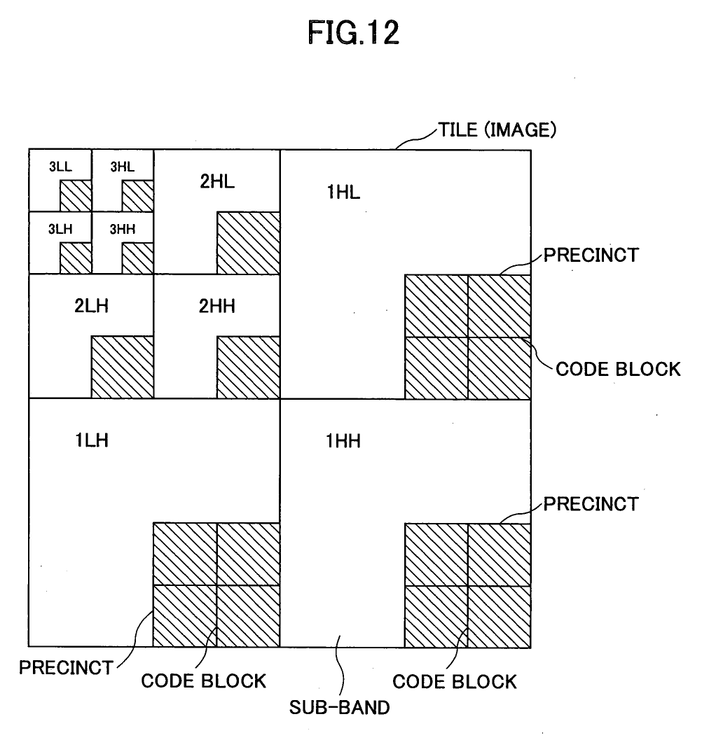

FIG. 12 is a schematic diagram for illustrating the corresponding relations among a tile, a precinct, and a code block in the case where the decomposition level is 3. A shaded region in each sub-band shown in FIG. 12 is a precinct corresponding to the same region of the original image. Each precinct in the sub-bands 1HL, 1LH, and 1HH is divided into one or more code blocks.

All code blocks included in a precinct are encoded into codes, and a part of the codes (for example, codes included in 3 bit planes from the MSB) constitutes a packet. A packet may be empty. The packets ordered in a desired progression order form encoded data. The packets are stored in the portion following the SOD marker of each tile shown in FIG. 11. If the packets of all precincts (all code blocks and all sub-bands) are gathered, the gathered packets constitute a layer that is a part of codes of the entire image (for example, the codes included in 3 bit planes from the MSB of the wavelet coefficients of the entire image). The more layers that are decoded, the better the quality of the reproduced image becomes. The number of decoded layers can be used as a measure of image quality. If all layers are gathered, the gathered layers constitute the codes of the entire image of all bit planes.

As described above, the packets of encoded data of JPEG 2000 have indexes indicating regions, image quality, components, and resolution, for example. A part of the codes can be extracted from the packet based on the indexes without decoding the encoded data. That is, encoded data are reconfigurable into other encoded data of which region (tile, precinct, and code block), image quality (layer, bit plane), component, and resolution are different from those of the original encoded data. One embodiment of the present invention employs this feature of JPEG 2000 encoded data.

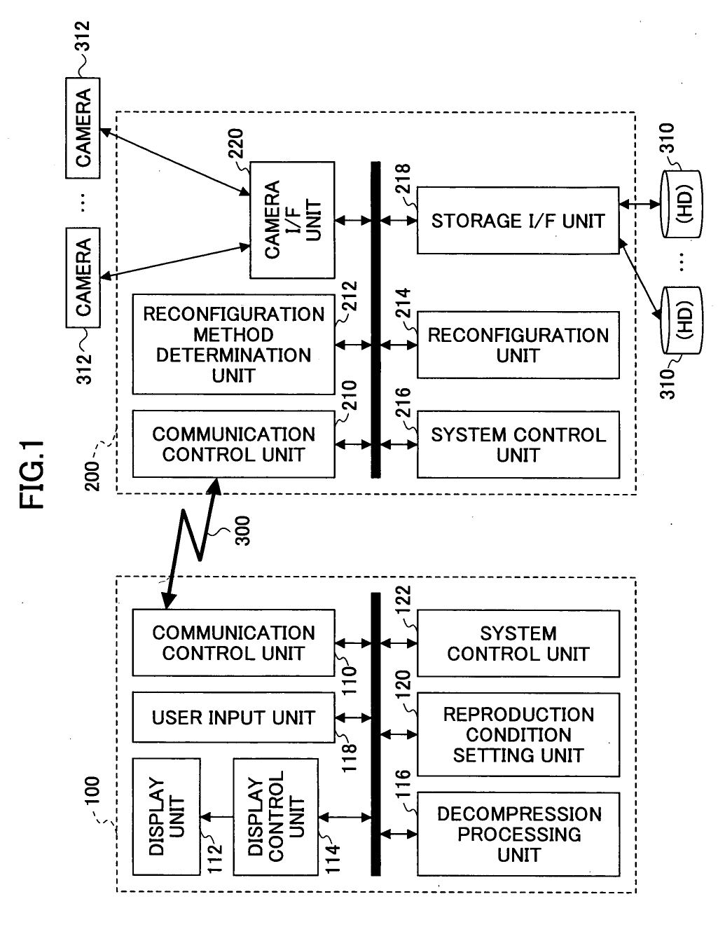

FIG. 1 is a block diagram for illustrating a system for reproducing a moving image according to an embodiment of the present invention. The system shown in FIG. 1 includes a reproduction apparatus (client apparatus) 100 and a transmission apparatus (server apparatus) 200. Both apparatuses 100 and 200 are connected to each other via a communication channel 300 such as a local area network (LAN), an Intranet, and the Internet, for example. The communication channel 300 may be wire-connected or wireless.

The reproduction apparatus 100 receives an encoded data stream into which a moving image is encoded in accordance with JPEG 2000, and reproduces one or more moving images.

The communication apparatus 200 retrieves an encoded data stream from a moving image source, reconfigures the retrieved encoded data stream, if necessary, and transmits the encoded data stream to the reproduction apparatus 100. Large capacity storage apparatuses 310 such as hard disk drives (HDD) and video cameras 312 are connected to the transmission apparatus 200 as the moving image source. Each video camera 312 captures a moving image, encodes the captured moving image into an encoded data stream in a lossless mode or at a low compression rate in accordance with JPEG 2000, and inputs the encoded data stream into the transmission apparatus 200. The large capacity storage apparatus 310 stores encoded data streams generated by the video camera 312 and other encoded data streams generated by other resources in accordance with JPEG 2000.

The encoded data stream can be reconfigured to include an operation in which codes that constitute a moving image of desired resolution level, layers, bit planes, divisional regions (tiles, precincts, and code blocks), and components (color component) are selected, and the selected codes are combined into a new encoded data stream; and an operation in which a frame rate is reduced by selecting only desired frames.

The reproduction apparatus 100 includes a communication control unit 110, a display unit 112 for displaying a moving image, for example, a display control unit 114, a user input unit 118 such as a pointing device (a mouse, for example) and a keyboard with which a user inputs instructions and information, a reproduction condition setting unit 120 for setting a reproduction condition based on the user's input via the user input unit 118, a decompression processing unit 116 for decompressing an encoded data stream, and a system control unit 122 for controlling the entire system and each unit of the reproduction apparatus 100.

The reproduction condition set by the reproduction condition setting unit 120 includes the following: an image size, the range of the moving image to be displayed, image quality (fineness), components (color/monochrome), and frame rate. If the bandwidth of the communication channel 300 can be changed, the reproduction condition may include the bandwidth of the communication channel 300 to be used for communication.

The transmission apparatus 200 includes the following: a communication control unit 210 for communicating with the reproduction apparatus 100, a reconfiguration method determination unit 212 for determining a reconfiguration method of an encoded data stream, a reconfiguration unit 214 for reconfiguring an encoded data stream input from the moving image sources 310 and 312, interface units 218 and 220 for interfacing with the moving image sources 310 and 312, respectively, and a system control unit 216 for controlling the entire system and each unit of the transmission apparatus 200.

The communication control unit 210 establishes communications with the reproduction apparatus 100 (negotiation step), and transmits an encoded data stream thereto (transmission step). The communication control unit 210 obtains information about the processing capacity for reproducing a moving image of the reproduction apparatus 100 and the traffic flowing through the communication channel during the negotiation step and the transmission step. The reconfiguration method determination unit 212 determines a reconfiguration method basically based on the reproduction condition received from the reproduction apparatus 100. The reconfiguration method determination unit 212 may take the information obtained by the communication control unit 210 about the processing capacity of the reproduction apparatus 100 and the traffic in the communication channel 300 into account. The reconfiguration method determined by the reconfiguration method determination unit 212 includes the following information needed for the reconfiguring of an encoded data stream input from the moving image sources: the resolution level, layers, bit planes, a divisional region (tiles, precincts, and code blocks), components that identify codes to be selected, and a frame rate that identifies frames to be extracted from the encoded data stream.

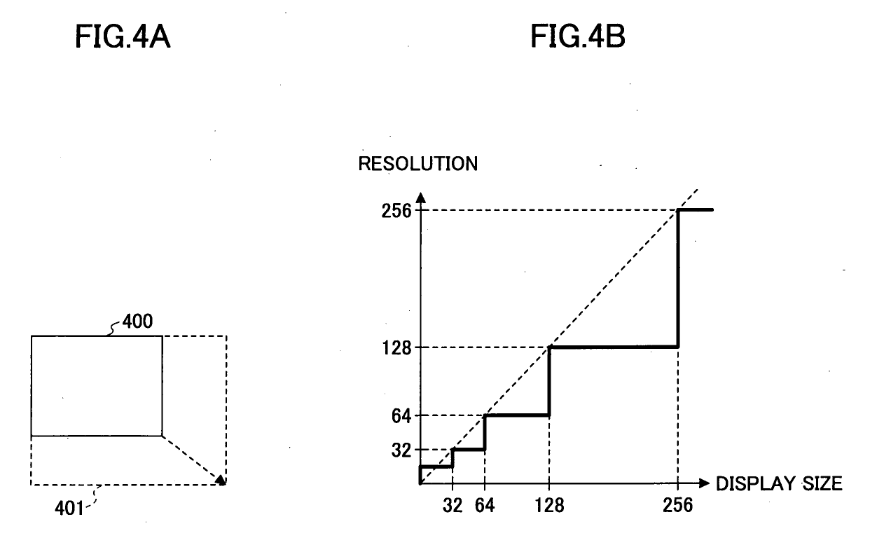

The reproduction apparatus 100 displays moving images in one or more windows 400 opened on the display unit 112 as shown in FIG. 4A. Using the user input unit 118 such as a mouse, a user can expand the window 400 as indicated by a broken line 401 or reduce the window 400.

According to an embodiment, a window 420, a pan/tilt button 421, and a zoom button 422 may be displayed on the screen as shown in FIG. 6A. While a moving image is displayed in the window 420, a user can imaginarily pan (pseudo-panning), tilt (pseudo-tilting), or zoom (pseudo-zooming) the moving image by operating the pan/tilt button 421 and the zoom button 422 with the user input unit 118 such as a mouse as shown in FIG. 6B. The panning, tilting, and zooming of the moving image correspond to the moving of the display range 424 right and left, the moving of the display range 424 up and down, and the expanding and the reducing of the display range 424, respectively.

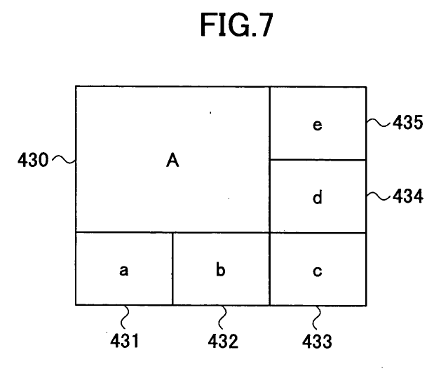

According to an embodiment as shown in FIG. 7, a large window 430 and five small windows 431 through 435 may be opened on the screen, for example. At most 5 moving images can be displayed in the small windows 431 through 435. A user can select one of the 5 moving images displayed in the small windows 431 through 435 using the user input unit 118 such as a mouse, and can expand and display the selected moving image in the large window 430. That is, the size of the selected moving image can be increased. Additionally, if the small windows 431 through 435 are closed, the user can expand the size of the large window 430, that is, the moving image displayed in the large window 430.

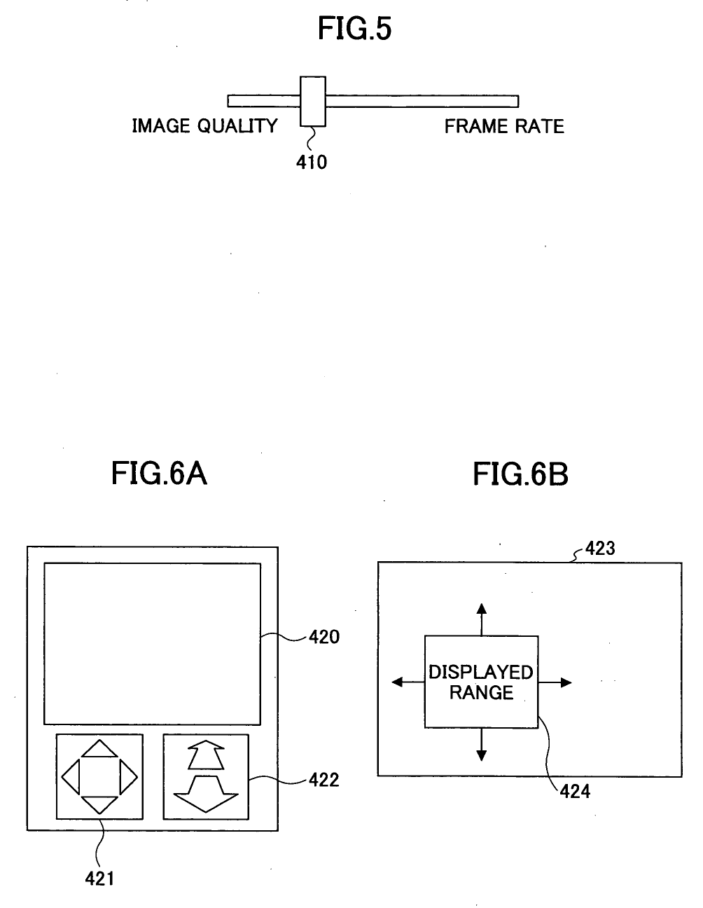

According to an embodiment, a sliding adjuster 410 for adjusting the balance between image quality and a frame rate may be provided on a screen as shown in FIG. 5. As the sliding adjuster 410 is moved to the left (to the direction of “image quality”), the image quality of a moving image is given more priority over frame rate. To the contrary, as the sliding adjuster 410 is moved to the right (to the direction of “frame rate”), the frame rate is given more priority over the image quality.

According to an embodiment, although not shown in the drawings, a button for selecting coloring may be provided on the screen. When color is selected with the button, a moving image is displayed in color. To the contrary, when monochrome is selected with the button, the moving image is displayed in monochrome.

According to another embodiment, although not shown in the drawings, a button or a sliding adjuster for designating bandwidth to be used for transmission from the transmission apparatus 200 to the reproduction apparatus 100 may be provided on the screen. The bandwidth of the communication channel 300 may be increased and decreased in response to an operation of the button or the sliding adjuster.

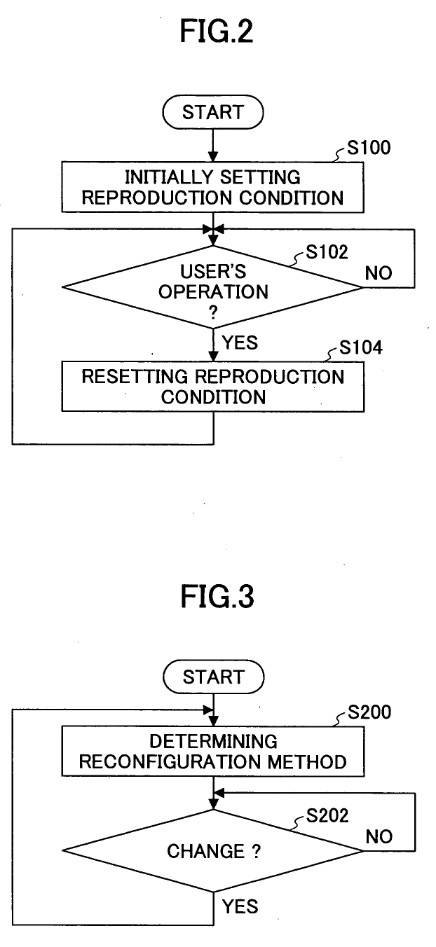

The reproduction condition setting unit 120 of the reproduction apparatus 100 is described with reference to a flowchart shown in FIG. 2. When a moving image starts being reproduced, the reproduction condition setting unit 120 initially sets a reproduction condition to default values (step S100). The reproduction condition includes designated display format, a display size, a display range, image quality, and frame rate, for example. The initialized reproduction conditions are transmitted to the transmission apparatus 200. Then, the reproduction condition setting unit 120 determines whether the user has operated the user input unit 118 for designating the reproduction condition (step S102). If the user has operated the user input unit 118 for designating the reproduction condition, the reproduction condition setting unit 120 resets the reproduction condition so that the user's operation is reflected in the reproduction condition (step S104). The reset reproduction condition is transmitted to the transmission apparatus 200.

If the window 400 is expanded as shown in FIG. 4, for example, the reproduction condition is changed in order to reflect the expanding of the window 400. While a moving image is shown in the window 420 shown in FIG. 6A, if the pan/tilt button 421 and the zoom button 422 are operated, the reproduction condition is changed in order to reflect the moving and the expanding (reducing) of the display range, respectively. If the sliding adjuster 410 is operated as shown in FIG. 5, the reproduction condition is changed in order to reflect the user's operation.

While the moving image shown in the small window 431 is also shown in the large window 430, if the small window 432 is selected, the reproduction condition is changed in order to reflect the expanding of the moving image shown in the small window 432 and the reducing in size of the moving image shown in the large window 430. According to the above embodiments, the moving image shown in the small window 432 is expanded and is shown in the large window 430.

While a moving image is displayed, if the button for selecting the coloring (color or monochrome) of the moving image is pressed, for example, the reproduction condition is changed in order to reflect the component of the moving image. If the button or the sliding adjuster for adjusting the bandwidth of the communication channel 300 is operated, the reproduction condition is changed in order to reflect the increase or decrease of the bandwidth.

The reconfiguration method determination unit 212 of the transmission apparatus 200 determines a reconfiguration method based on the reproduction condition received from the reproduction apparatus 100, but the reconfiguration method determination unit 212 takes into consideration traffic in the communication channel 300 and the processing capacity of the reproduction apparatus 100. As shown in FIG. 3, the reconfiguration method determination unit 212 determines the reconfiguration method in response to receipt of the reproduction condition (step S200). Then, the reconfiguration method determination unit 212 determines whether any change that is not negligible has occurred in the reproduction condition and the traffic in the communication channel 300 (step S202). If such a change is identified, the reconfiguration method determination unit 212 determines the reconfiguration method again (step S200).

Specifically, the reconfiguration method determination unit 212 determines the resolution of the encoded data that form a new encoded data stream based on the relation between display size and resolution shown in FIG. 4B, for example.

The reconfiguration method determination unit 212 further determines the region of the encoded data that are to be selected for reconfiguring by tiles, precincts, or code blocks, based on the reproduction condition of the display range described with reference to FIG. 6.

The reconfiguration method determination unit 212 further determines the ratio between layers, bit planes, or frames of the encoded data that are selected and those that are not selected, based on the reproduction condition regarding the image quality and the frame rate.

The reconfiguration method determination unit 212 further determines the components that are selected for reconfiguration based on the reproduction condition about the component.

When determining the ratio between layers, bit planes, or frames of the encoded data that are selected and those that are not selected, the reconfiguration method determination unit 212 takes into consideration the reproduction condition about the bandwidth and the traffic in the communication channel 300.

Needless to say, if multiple moving images are to be reproduced, a reconfiguration method is determined for each moving image.

The reconfiguration unit 214 reconfigures the encoded data stream input from the large capacity storage device 310 and/or the video camera 312 in accordance with the reconfiguration method determined by the reconfiguration method determination unit 212. The reconfigured encoded data stream is transmitted to the reproduction apparatus 100. The decompression processing unit 116 of the reproduction apparatus 100 decompresses the encoded data stream received from the transmission apparatus 200. The display control unit 114 displays the decompressed moving image on the display unit 112. The display control unit 114 adjusts the display size of the moving image, if necessary.

As described above, the transmission apparatus 200 transmits, to the reproduction apparatus 100, the encoded data stream, the resolution, the image quality, the region, the components, and the frame rate that meet the reproduction conditions designated by the user's operation. As a result, the reproduction apparatus 100 can reproduce the moving image in the manner that fits the user's designation.

The reconfigured encoded data stream is smaller in data size than the not-yet-reconfigured encoded data stream since the reconfigured encoded data stream does not include encoded data that do not fit the user's designation. If the frame rate is reduced in accordance with the reproduction condition, the reconfigured encoded data stream includes fewer frames than the not-yet-reconfigured encoded data stream. If the resolution, for example, is reduced in accordance with the reproduction condition, each frame of the reconfigured encoded data stream includes less encoded data than that of the not-yet-reconfigured encoded data stream. As a result, the reproduction apparatus 100 can process the reconfigured encoded data stream quicker than the not-yet-reconfigured encoded data stream (the original encoded data stream). Specifically, each frame of the reconfigured encoded data stream can be transmitted quicker than that of the not-yet-reconfigured encoded data stream. The decompression processing unit 116 can decompress each frame of the reconfigured encoded data stream quicker than that of the not-yet-reconfigured encoded data stream. The display control unit 114 can adjust the image size of each frame of the reconfigured encoded data stream quicker than the image size of the frame of the not-yet-reconfigured encoded data stream.

Even if the bandwidth is fixed, the system according to the above embodiment can reproduce more than one moving image simultaneously by increasing the frame rates of the moving images since the system can finish processing each frame quicker. Alternatively, the system can reduce the bandwidth of the communication channel 300 maintaining the same reproduction condition.

The pseudo-panning/tilting/zooming operation is realized by reconfiguring the encoded data. The system according to an embodiment of the present invention does not require complex processing such as the averaging of pixel values nor the increasing of scan lines. The transmission apparatus 200 only needs to transmit the reconfigured encoded data stream that is smaller in data size than the not-yet-reconfigured encoded data stream. Since unneeded frames are not transmitted, the time period required for the transmission can be reduced. As a result, even if multiple reproduction apparatuses 100 are connected to the transmission apparatus 200, the transmission apparatus 200 can transmit a moving image to each reproduction apparatus 100.

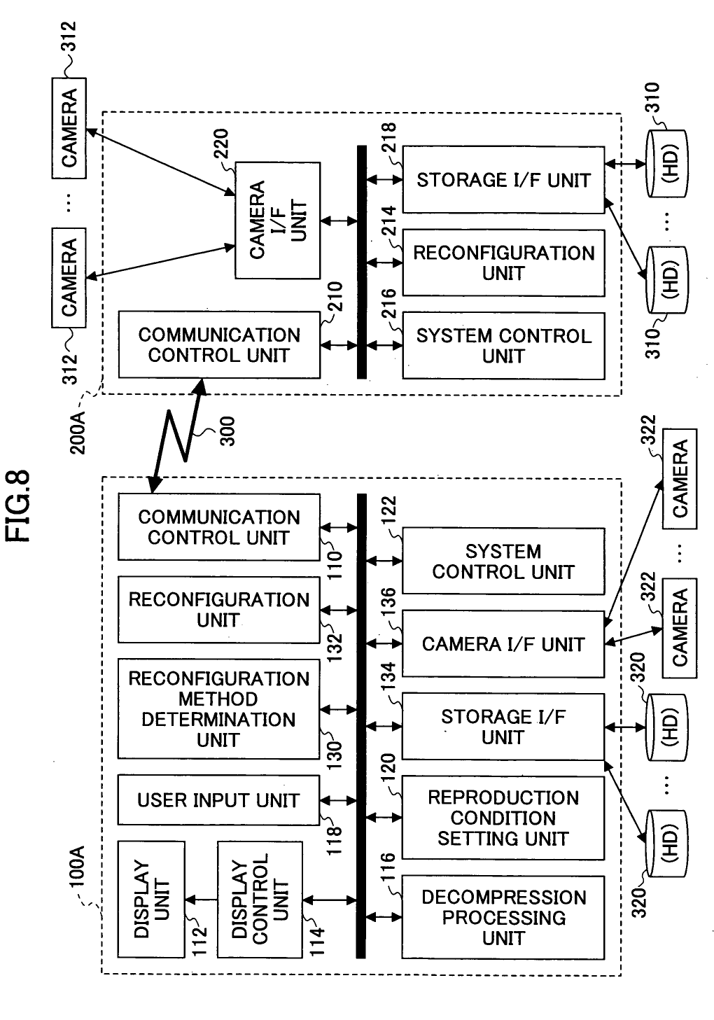

FIG. 8 is a block diagram showing a system for reproducing a moving image according to another embodiment of the present invention. The structure of a reproduction apparatus 100A of the system is nearly identical to that of the reproduction apparatus 100 shown in FIG. 1, and the structure of a transmission apparatus 200A of the system is nearly identical to that of the transmission apparatus 200 shown in FIG. 1. The reproduction apparatus 100A has large capacity storage devices 320 such as hard disk drives and video cameras 322 as local moving image sources. The reproduction apparatus 100A can reproduce a moving image provided by the local moving image sources. Each video camera 322 captures a moving image, compresses the captured moving image into encoded data in the lossless mode or at a low compression ratio by JPEG 2000, and inputs the encoded data into the reproduction apparatus 100A. The large capacity storage apparatus 320 stores encoded data streams provided by the video cameras 322, for example.

The reproduction apparatus 100A additionally includes a storage interface (I/F) unit 134 that interfaces the large capacity storage devices 320 and a camera interface (I/F) unit 136 that interfaces the video cameras 322, a reconfiguration method determination unit 130, and a reconfiguration unit 132. The transmission apparatus 200A does not include a reconfiguration method determination unit.

The reconfiguration method determination unit 130 is the same in function as the reconfiguration method determination unit 212 shown in FIG. 1. The reconfiguration method determination unit 130 determines both a reconfiguration method in which the encoded data stream input from the moving image sources (310, 312) provided to the transmission apparatus 200A is reconfigured and a reconfiguration method in which the encoded data stream input from the local moving image sources (320, 322) is reconfigured based on the reproduction condition set by the reproduction condition setting unit 120 taking the traffic in the communication channel 300 into consideration. The reconfiguration method in which the encoded data stream from the moving image sources 310 and 312 are reconfigured is transmitted to the transmission apparatus 200A.

The reconfiguration unit 132 reconfigures only the encoded data stream input by the local moving image sources 320 and 322 using the reconfiguration method related thereto. The reconfiguration unit 214 reconfigures the encoded data stream input from the moving image sources 310 and 312 at the transmission apparatus 200A side using the reconfiguration method received from the reproduction apparatus 100A.

In the system for reproducing a moving image according to this embodiment, the reproduction apparatus 100A is provided with encoded data streams of moving images from the local moving image sources (320, 322) directly connected to the reproduction apparatus 100A and the moving image sources (310, 312) connected to the transmission apparatus 200A. Since the resolution, the image quality, the region, the component, and the frame rate of the encoded data stream fit the reproduction condition designated by the user's operation, the reproduction apparatus 100A can reproduce the moving image in the manner designated by the user.

Additionally, the encoded data of a frame after the reconfiguration is smaller in data size than the encoded data of the frame before the reconfiguration since the encoded data of the frame after the reconfiguration does not include encoded data that do not fit the user's designation. As a result, compared to the case in which the reproduction apparatus 100A acquires the encoded data before the reconfiguration, the reproduction apparatus 100A can reduce the time period in which the frame is decompressed and the size of the moving image is adjusted. Additionally, the time period required for receiving each frame of the moving image received from the transmission apparatus 200A can be reduced. The reduction in the processing time makes it possible to increase the frame rate while maintaining the used bandwidth constant and increase the number of moving images simultaneously reproducible. In other words, it is possible to reduce the needed bandwidth maintaining the reproduction condition constant. The transmission apparatus 200A can reduce processing time for transmitting each frame since the data size of each frame to be transmitted is reduced. This becomes a great advantage in an environment in which multiple reproduction apparatuses are connected to the transmission apparatus 200A. The pseudo-panning operation, the pseudo-tilting operation, and the pseudo-zooming operation can be realized by only reconfiguring the encoded data. Complex processing such as the averaging of pixel values and the increasing of scan lines is not required.

It is apparent that in the systems for reproducing a moving image according to the above embodiments of the present invention, the reproduction apparatuses and the transmission apparatuses can be realized using generally structured computers. One embodiment of the present invention includes a program therefore, especially, programs for realizing the functions of the reproduction condition setting unit, the reconfiguration method determination unit, and the reconfiguration unit, and various recording media storing the same. As is apparent from the above description, a method of reproducing a moving image performed by the system according to one embodiment of the present invention is characterized by a step of setting a reproduction condition based on a user's operation, a step of determining a reconfiguration method based on the reproduction condition, and a step of reconfiguring an encoded data stream in accordance with the reconfiguration method. One embodiment of the present invention includes a program for causing one or more computers to perform the above steps, and further includes various recording media storing the same.

As described above, according to one embodiment of the present invention, the reproduction apparatus can acquire, from a moving image source or transmission apparatus, an encoded data stream reconfigured so that the encoded data stream fits a user's intention and reproduce the moving image in the manner fitting the user's intention. The encoded data of each frame that are acquired into the reproduction apparatus include less codes that are not needed for the reproducing of the moving image, and are smaller in data size than the encoded data before the reconfiguration. Compared to the case in which the reproduction apparatus acquires the encoded data before the reconfiguration, the time period required for receiving a frame, for decompressing, and for adjusting the image size can be reduced. According to the reducing of processing time, the frame rate can be increased without increasing the used bandwidth, and the number of moving images reproducible simultaneously can be increased. Additionally, the needed bandwidth under the same reproduction condition can be reduced. Since the data amount of a frame to be transmitted is reduced, the transmission apparatus can reduce processing time of the frame. The pseudo-panning operation, the pseudo-tilting operation, and the pseudo-zooming operation can be realized by only reconfiguring the encoded data. Complex operations such as the averaging of pixel values and the increasing of scan lines are not needed.

In the above embodiments, JPEG 2000 is used as a coding method. According to another embodiment, a coding method other than JPEG 2000 that can encode a moving image into an encoded data stream that is reconfigurable without decoding the encoded data stream may be used as the coding method.

The present invention is not limited to these embodiments, but variations and modifications may be made without departing from the scope of the present invention.

This patent application is based on Japanese Priority Patent Application No. 2003-043189 filed on Feb. 20, 2003, the entire contents of which are hereby incorporated by reference.

What is claimed is:

1. A system for reproducing a moving image from an encoded data stream encoded in accordance with a coding method, the encoded data stream being reconfigurable without decoding, comprising:
a reproduction apparatus to reproduce the moving image; and
a transmission apparatus to transmit the encoded data stream to the reproduction apparatus, the transmission apparatus being connected to the reproduction apparatus via a communication channel, wherein the reproduction apparatus further comprises:
a setting unit to set a reproduction condition in response to a user's operation, the reproduction condition being transmitted to the transmission apparatus, the transmission apparatus further comprises:
a determination unit to determine a reconfiguration method of the encoded data stream based on the reproduction condition received from the reproduction apparatus, and
a reconfiguration unit to reconfigure the encoded data stream to be transmitted to the reproduction apparatus based on the reconfiguration method determined by the determination unit.

2. The system as claimed in claim 1, wherein the reproduction condition set by the setting unit includes at least one of a display size, a display range, image quality, a color component, and a frame rate.

3. The system as claimed in claim 2, wherein the setting unit adjusts the display size included in the reproduction condition in response to the user's operation for changing a window size in which the moving image is displayed.

4. The system as claimed in claim 2, wherein the setting unit changes the display size included in the reproduction condition in response to the user's operation for selecting a window in which the moving image is displayed.

5. The system as claimed in claim 2, wherein the setting unit adjusts the display range included in the reproduction condition in response to the user's operation for panning and tilting.

6. The system as claimed in claim 2, wherein the setting unit adjusts the display range included in the reproduction condition in response to the user's operation for zooming.

7. The system as claimed in claim 2, wherein the setting unit adjusts the image quality and the frame rate in the reproduction condition in response to the user's operation for adjusting a balance between the image quality and the frame rate.

8. A system for reproducing a moving image from an encoded data stream encoded in accordance with a coding method, the encoded data stream being reconfigurable without decoding, comprising:
a reproduction apparatus to reproduce the moving image; and
a transmission apparatus to transmit the encoded data stream to the reproduction apparatus, the transmission apparatus being connected to the reproduction apparatus via a communication channel, wherein the reproduction apparatus further comprises:
a setting unit to set a reproduction condition in response to a user's operation, the reproduction condition being transmitted to the transmission apparatus; and
a determination unit to determine a reconfiguration method of the encoded data stream based on the reproduction condition received from the reproduction apparatus, the transmission apparatus further comprises:
a reconfiguration unit to reconfigure the encoded data stream to be transmitted to the reproduction apparatus based on the reconfiguration method determined by the determination unit.

9. The system as claimed in claim 8, wherein the reproduction condition set by the setting unit includes at least one of a display size, a display range, image quality, a color component, and a frame rate.

10. The system as claimed in claim 9, wherein the setting unit adjusts the display size included in the reproduction condition in response to the user's operation for changing a window size in which the moving image is displayed.

11. The system as claimed in claim 9, wherein the setting unit changes the display size included in the reproduction condition in response to the user's operation for selecting a window in which the moving image is displayed.

12. The system as claimed in claim 9, wherein the setting unit adjusts the display range included in the reproduction condition in response to the user's operation for panning and tilting.

13. The system as claimed in claim 9, wherein the setting unit adjusts the display range included in the reproduction condition in response to the user's operation for zooming.

14. The system as claimed in claim 9, wherein the setting unit adjusts the image quality and the frame rate in the reproduction condition in response to the user's operation for adjusting a balance between the image quality and the frame rate.

15. A system for reproducing a moving image from an encoded data stream encoded in accordance with a coding method, the encoded data stream being reconfigurable without decoding, comprising:
a moving image source; and
a reproduction apparatus to reproduce the moving image obtained from the moving image source, wherein the reproduction apparatus further comprises:
a setting unit to set a reproduction condition in response to a user's operation, the reproduction condition being transmitted to the transmission apparatus;
a determination unit to determine a reconfiguration method of the encoded data stream based on the reproduction condition received from the reproduction apparatus, and
a reconfiguration unit to reconfigure the encoded data stream to be transmitted to the reproduction apparatus based on the reconfiguration method determined by the determination unit.

16. The system as claimed in claim 15, wherein the reproduction condition set by the setting unit includes at least one of a display size, a display range, image quality, a color component, and a frame rate.

17. The system as claimed in claim 16, wherein the setting unit adjusts the display size included in the reproduction condition in response to the user's operation for changing a window size in which the moving image is displayed.

18. The system as claimed in claim 16, wherein the setting unit changes the display size included in the reproduction condition in response to the user's operation for selecting a window in which the moving image is displayed.

19. The system as claimed in claim 16, wherein the setting unit adjusts the display range included in the reproduction condition in response to the user's operation for panning and tilting.

20. The system as claimed in claim 16, wherein the setting unit adjusts the display range included in the reproduction condition in response to the user's operation for zooming.

21. The system as claimed in claim 16, wherein the setting unit adjusts the image quality and the frame rate in the reproduction condition in response to the user's operation for adjusting a balance between the image quality and the frame rate.

22. A reproduction apparatus for reproducing a moving image by decoding an encoded data stream from a transmission apparatus, comprising:
a setting unit to set a reproduction condition in response to a user's operation, wherein the reproduction apparatus transmits the reproduction condition set by the setting unit to the transmission apparatus, and receives an encoded data stream reconfigured by a reconfiguration method determined in response to the transmitted reproduction condition from the transmission apparatus.

23. A reproduction apparatus for reproducing a moving image by decoding an encoded data stream from a transmission apparatus, comprising:
a setting unit to set a reproduction condition in response to a user's operation; and
a determination unit to determine a reconfiguration method for reconfiguring the encoded data stream based on the reproduction condition set by the setting unit, wherein the reproduction apparatus transmits the reconfiguration method determined by the determination unit to the transmission apparatus, and receives an encoded data stream reconfigured by the transmitted reconfiguration method from the transmission apparatus.

24. A transmission apparatus for transmitting an encoded data stream compressed in accordance with JPEG 2000 to a reproduction apparatus connected thereto via a communication channel, comprising:
a determination unit to determine a reconfiguration method for reconfiguring the encoded data stream based on a reproduction condition transmitted from the reproduction apparatus; and
a reconfiguration unit to reconfigure the encoded data stream to be transmitted to the reproduction apparatus based on the reconfiguration method determined by the determination unit.

25. A method of reproducing a moving image encoded into an encoded data stream in accordance with JPEG 2000, comprising:
setting a reproduction condition in response to a user's operation;
determining a reconfiguration method of the encoded data stream based on the set reproduction condition;
reconfiguring the encoded data stream based on the determined reconfiguration method; and
reproducing the moving image from the reconfigured encoded data stream.

26. The method as claimed in claim 25, wherein the reproduction condition set when setting the reproduction condition includes at least one of a display size, a display range, image quality, a color component, and a frame rate.

27. The method as claimed in claim 26, wherein the display size included in the reproduction condition is adjusted in response to the user's operation for changing a window size in which the moving image is displayed in the step of setting the reproduction condition.

28. The method as claimed in claim 26, wherein the display size included in the reproduction condition is changed in response to the user's operation for selecting a window in which the moving image is displayed in the step of setting the reproduction condition.

29. The method as claimed in claim 26, wherein the display range included in the reproduction condition is changed in response to the user's operation for panning and tilting in the step of setting the reproduction condition.

30. The method as claimed in claim 26, wherein the display range included in the reproduction condition is adjusted in response to the user's operation for zooming in the step of setting the reproduction condition.

31. The method as claimed in claim 26, wherein the image quality and the frame rate in the reproduction condition is adjusted in response to the user's operation for adjusting a balance between the image quality and the frame rate in the step of setting the reproduction condition.

32. An article of manufacture having one or more recordable medium storing instructions which, when executed by a computer, cause the computer to perform a method of reproducing a moving image encoded into an encoded data stream in accordance with JPEG 2000 by:
setting a reproduction condition in response to a user's operation;
determining a reconfiguration method of the encoded data stream based on the set reproduction condition; and
reconfiguring the encoded data stream based on the determined reconfiguration method.
